(19) United States
(12) Patent Application Publication
(10) Pub. No.: US 2007/0028026 A1
(43) Pub. Date: Feb. 1, 2007

(54) Digital multimedia transfer rate controlling

(76) Inventors: You-Min Yeh, Chi-Lung City (TW); Chih-Chieh Yang, Taipei City (TW)

Correspondence Address: FISH & RICHARDSON PC, P.O. BOX 1022, MINNEAPOLIS, MN, 55440-1022, US

(21) Appl. No.: 11/191,188

(22) Filed: Jul. 27, 2005

(51) Int. Cl. H04N 7/12; H04B 1/66; H04N 11/04; G06F 12/00; G06F 13/28; H04N 11/02; G06F 13/00; G06F 3/06; G06F 12/06

(52) U.S. Cl. 711/4; 375/240.25; 711/2; 711/100; 711/105

(57) ABSTRACT

An apparatus that includes a controller to regulate a rate of transfer of MPEG transport stream packets from a first storage device to a second storage device based on transfer rate control information derived from at least some of the MPEG transport stream packets. For example, the transfer rate control information may include time information, and the time information may include program clock references. In some examples, the first storage device can be a hard disk drive or a dynamic random access memory, and the second storage device can be a Blu-ray Disc recorder.

### BACKGROUND

This description relates to digital multimedia transfer rate controlling.

A digital television signal typically includes modulated multiplexed transport streams that are encoded according to, e.g., an MPEG (Moving Picture Experts Group) standard, defined in ISO/IEC MPEG specification, also referred to as ISO/IEC 13818. The MPEG encoded signals are modulated using, e.g., vestigial side band (VSB) modulation or quadrature amplitude modulation (QAM). The digital television signal may comply with, e.g., ATSC (Advanced Television Systems Committee), DVB (Digital Video Broadcasting), or ISDB (Integrated Services Digital Broadcasting) standard.

A digital TV recorder can record digital TV programs to a hard disk drive, a digital VHS tape (promoted by Japan Victor Corporation), or a Blu-ray recordable or rewritable disc (which complies with the Blu-ray Disc standard established by Blu-ray Disc Association).

### SUMMARY

In general, in one aspect, the invention features an apparatus that includes a controller to regulate a rate of transfer of MPEG transport stream packets from a first storage device to a second storage device based on transfer rate control information derived from at least some of the MPEG transport stream packets.

Implementations of the invention may include one or more of the following features. The transfer rate control information includes time information. The time information includes program clock references (PCRs). The controller comprises a local PCR timer, in which a packet having a PCR is transferred when the local PCR timer has a value that is equal to or greater than a value of the PCR. The local PCR timer, upon receiving a first packet having a PCR, stores the value of the PCR and starts to increment a counter periodically. The local PCR timer is reset when the value of the PCR deviates more than a predetermined amount from the value of the local PCR timer. The controller regulates transfers of packets without a PCR based on a difference between PCRs of two packets that have PCRs and a number of packets between the two packets that have PCRs. The controller performs integer operations. The controller comprises an accumulator and adders. In some examples, the rate of transfer of a packet is estimated according to the transfer rate control information derived from previous packets having PCRs. In some other examples, the rate of transfer is estimated by applying at least one of averaging, low-pass filtering, and moving averaging operations to the transfer rate control information derived from previous packets having PCRs. In some other examples, the controller determines the rate of transfer according to a parameter representing a target transfer rate, wherein the parameter is embedded in the MEPG transport stream packets. In some other examples, the controller regulates the rate of transfer based on a comparison of the derived transfer rate control information with local transfer rate control information. The local transfer rate information includes local program clock references that are used for decoding the transport stream packets. The controller regulates the rate of transfer also based on information about one or more previous packets that were sent to the second storage device. The information about the previous packet includes a duration of time since the previous packet was sent to the second storage device. The first storage device includes a rotating medium or a dynamic random access memory (DRAM). The second storage device includes a digital VHS recorder, a Blu-ray Disc recorder, or a High-Density DVD recorder. The transport stream transfer rate controller regulates the rate of transfer without performing video compression or decompression.

In general, in another aspect, the invention features an apparatus that includes a first controller to control transfer of MPEG transport stream packets from a first storage to a DRAM, and to control transfer of at least some of the MPEG transport stream packets from the DRAM to a second storage; and a second controller to regulate at least one of (a) a rate of transfer of the packets from the first storage to the DRAM and (b) a rate of transfer of the packets from the DRAM to the second storage, based on transfer rate control information in the MPEG transport stream packets.

Implementations of the invention may include one or more of the following features. The transfer rate control information includes time information. The time information includes program clock references. The second controller regulates the rate of transfer based on a comparison of embedded transfer rate control information with local transfer rate control information. The local transfer rate control information includes local program clock references that are used for decoding the transport stream packets. The second controller regulates the rate of transfer also based on information about a previous packet that was sent to the second storage. The apparatus includes a user interface to allow a user to select at least one program to transfer from the first storage to the second storage. The apparatus includes a transport stream demultiplexer to select transport stream packets associated with the user-selected program. The transport stream demultiplexer selects the transport stream packets based on packet identifiers.

In general, in another aspect, the invention features a digital recorder that includes a demultiplexer to generate a data file of information about particular packets in a stream of MPEG packets, the information being configured to enable faster fetching of the particular packets; a hard disk drive to store the MPEG packets and the data file; a recorder to store at least some of the MPEG packets on a removable medium; a first controller to control playback of the MPEG packets from the hard disk drive based at least in part on the data file and to control storage of the MPEG packets in the hard disk drive and transfer of the some of the MPEG packets from the hard disk drive to the recorder; and a memory to temporarily store packets transferred from the hard disk drive to the recorder.

Implementations of the invention may include one or more of the following features. The digital recorder includes a second controller to regulate a transfer rate of the MPEG packets from the hard disk drive to the recorder according to transfer rate control information in the MPEG packets. The transfer rate control information includes time information. The time information includes program clock references. The controller controls selective decoding of the MPEG packets to enable trick mode operation. The controller selects the MPEG packets to be decoded based on information in the data file. The data file identifies packets according to whether they require other packets in order to be processed or can be processed independently. The data file includes information about which packets are at the start of at least one of intra-coded, predictive-coded, and bi-directionally predictive-coded frames. The digital recorder includes a demodulator to demodulate a modulated MPEG transport stream signal and generate the stream of MPEG packets.

In general, in another aspect, the invention features a digital recorder that includes a demultiplexer to insert data about particular packets of a series of MPEG transport stream packets into at least some of the MPEG transport stream packets, the data being configured to aid faster fetching of the particular packets; and a controller to control transfer of at least some of the MPEG transport stream packets from a first storage to a second storage, the inserted data being removed prior to sending the MPEG transport stream packets to the second storage.

In general, in another aspect, the invention features a method that includes regulating a rate of transfer of MPEG transport stream packets from a first storage to a second storage based on transfer rate control information embedded in the MPEG transport stream packets.

Implementations of the invention may include one or more of the following features. The transfer rate control information includes time information. The time information includes program clock references (PCRs). The method includes transferring a packet having a PCR when a local PCR timer has a value that is equal to or greater than a value of the PCR. The local PCR timer, upon receiving a first packet having a PCR, stores the value of the PCR and starts to increment a counter periodically. The local PCR timer is reset when the value of the PCR deviates more than a predetermined amount from the value of the local PCR timer. The method includes regulating a rate of transfer of a packet without a PCR based on a difference between PCRs of two packets having PCRs and a number of packets between the two packets that have PCRs. The method includes performing integer operations to determine a time interval between packets that do not have PCRs. In some examples, the method includes estimating the rate of transfer for packets without PCRs based on the transfer rate control information derived from previous packets having PCRs. In some other examples, the rate of transfer is estimated by at least one of averaging, low-pass filtering, and moving averaging the transfer rate control information derived from previous packets having PCRs. In some other examples, the rate of transfer is determined based on a parameter representing a target transfer rate, wherein the parameter is embedded in the MEPG transport stream packets.

Regulating the rate of transfer includes regulating the rate of transfer based on a comparison of the embedded transfer rate control information with local transfer rate control information. The local transfer rate information includes local program clock references that are used for decoding the transport stream packets. Regulating the rate of transfer includes regulating the rate of transfer also based on information about a previous packet that was sent to the second storage. The information about the previous packet includes a duration of time since the previous packet was sent to the second storage. Regulating the rate of transfer includes regulating a rate of transfer of MPEG transport stream packets from a hard disk drive to a digital VHS recorder, a Blu-ray Disc recorder, or a High-Density DVD recorder. Regulating the rate of transfer includes regulating the rate of transfer without performing video compression or decompression.

In general, in another aspect, the invention features a method that includes transferring MPEG transport stream packets from a first storage to a dynamic random access memory (DRAM); transferring at least some of the MPEG transport stream packets from the DRAM to a second storage; and regulating at least one of (a) a rate of transfer of the packets from the first storage to the DRAM and (b) a rate of transfer of the packets from the DRAM to the second storage, based on transfer rate control information in the MPEG transport stream packets.

Implementations of the invention may include one or more of the following features. The transfer rate control information includes time information. The time information includes program clock references in the packets. Regulating the rate of transfer includes regulating the rate of transfer based on a comparison of the transfer rate control information embedded in the packets with local transfer rate control information. The local transfer rate control information includes a local program clock reference timer used for decoding the transport stream packets. Regulating the rate of transfer includes regulating the rate of transfer also based on information about a previous packet that was sent to the second storage. The information about the previous packet includes a duration of time since the previous packet was sent to the second storage. The method includes providing a user interface to allow a user to select at least one program to transfer from the first storage to the second storage. The method includes selecting transport stream packets associated with the user-selected program. Selecting the transport stream packets includes selecting the transport stream packets based on packet identification (PID) codes.

In general, in another aspect, the invention features a method that includes generating a data file of information about particular packets in a stream of MPEG packets, the information being configured to enable faster fetching of the packets; storing the MPEG packets and the data file in a hard disk drive; controlling decoding of the MPEG packets retrieved from the hard disk drive based at least in part on the data file; transferring at least some of the MPEG packets from the hard disk drive to a memory; and transferring at least some of the MPEG packets from the memory to a removable medium.

Implementations of the invention may include one or more of the following features. The method includes regulating at least one of (a) a transfer rate of the MPEG packets from the hard disk drive to the memory and (b) a transfer rate of the MPEG packets from the memory to the removable medium, based on transfer rate control information embedded in at least some of the MPEG transport stream packets. The transfer rate control information includes time information. The method includes selectively decoding the MPEG packets to enable trick mode operation. The method includes selecting packets to be decoded based on information in the data file. The data file includes information about which packets are associated with the start of at least one of intra-coded, predictive-coded, and bi-directionally predictive-coded frames. The method includes demodulating a modulated MPEG transport stream signal and generating the stream of MPEG packets.

In general, in another aspect, the invention features a method that includes inserting data about particular packets of a series of MPEG transport stream packets into at least some of the MPEG transport stream packets, the data being configured to aid faster fetching of the particular packets; and transferring at least some of the MPEG transport stream packets from a first storage to a second storage, including removing the inserted data prior to sending the MPEG packets to the second storage.

All of the publications, patent applications, patents, or other references mentioned are incorporated by reference. In case of conflict with the references incorporated by reference, the present specification, including definitions, will control.

### DESCRIPTION OF DRAWINGS

FIG. 1 shows a schematic diagram of a digital TV recorder.

FIGS. 2A-2C show packets.

FIGS. 3 and 7 show signal paths for transferring transport stream packets.

FIGS. 4 and 8 show processes.

FIG. 5 shows a schematic diagram of a transport stream transfer rate controller.

FIG. 6 shows an interval calculator.

### DESCRIPTION

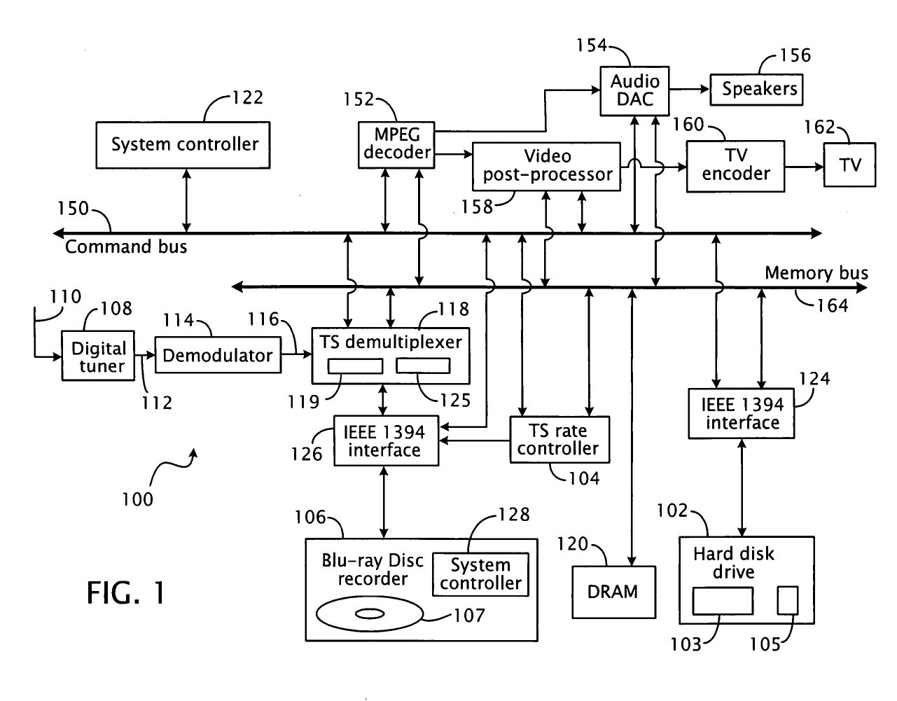

In FIG. 1, a digital TV recorder 100 allows a user to store digital TV programs in a hard disk drive 102 or a Blu-ray disc 107 or both as MPEG transport stream packets 103. In addition, the recorder 100 generates a meta data file 105 that includes meta data (e.g., management data, control data, or auxiliary data) about particular packets that is useful in processing the digital TV program, e.g., by enabling faster searching of the packets. The meta data file enables the recorder 100 to function as a locally controllable video recorder, also referred to as a “personal video recorder,” allowing the user to pause, reverse, or increase or decrease the speed of a live digital TV program while the recorder simultaneously records the live program. The meta data file has format that does not necessarily comply with any industry standard. The format of the meta data file may vary depending on the application and the type of information included in the meta data file. The user can also use a Blu-ray Disc recorder 106 to record and control the playback of the digital TV programs in a Blu-ray disc 107 according to an industry standard format.

In the description, “storing a digital TV program” means storing data (e.g., MPEG transport stream packets, program elementary stream packets, or program stream packets) that can later be used to reproduce the digital TV program. “Processing a digital TV program” means processing data to decode encoded data to, for example, reproduce the digital TV program or render a modified version (e.g., fast forward, fast reverse, slow motion) of the digital TV program. A “live digital TV program” refers to a digital TV program that is being broadcast or transmitted to the user at the same time that the user is viewing the program. “Multimedia” means two or more different media that convey information, such as text, audio, graphics, animation, video, and interactive content. A “program” can be reproduced from packets having a common time base, and different programs can be reproduced from packets having independent time bases.

A feature of the digital TV recorder 100 is that the digital TV programs stored in the hard disk drive 102 can be transferred to the Blu-ray Disc recorder 106, which records the program in the Blu-ray disc 107 in a format that conforms to an industry standard. The user can store digital TV programs in the hard disk drive 102, access the digital TV programs with the using additional functions that can be implemented using the meta data file, and selectively record the digital TV programs in the Blu-ray disc 107.

Having the ability to record the programs to Blu-ray discs 107 has several advantages. The user can erase the digital TV programs on the hard disk drive 102 after recording the programs to Blu-ray discs 107, thus freeing up space in the hard disk drive 102 to record additional programs. The Blu-ray discs 107 are more convenient to carry than the hard disk drive 102. The user can organize the programs by recording a collection of programs having the same genre on a Blu-ray disc 107 in a sequence chosen by the user. Because the Blu-ray Disc recorder 106 records the programs to the Blu-ray disc 107 according to an industry standard, the user has the flexibility of using Blu-ray disc drives made from a variety of manufacturers to watch the recorded digital TV programs.

Copy protection mechanism that are implemented according to, e.g., data encryption standard (DES), triple DES, or advanced encryption standard (AES), may be provided to prevent un-authorized copying of digital TV programs from the hard disk drive 102 to the Blu-ray disc 107. A warning message is displayed when the user attempts to copy copyrighted material without an authorization code.

In the digital TV recorder 100, a digital tuner 108 receives a digital television signal 110 from, e.g., a cable or an antenna. The signal 110 includes audio and video signals that are compressed using the MPEG standard and modulated using VSB or QAM modulation. The tuner 108 filters the signal 110 to select a physical channel, and outputs a modulated transport stream 112 having contents of the physical channel.

The term “physical channel” refers, for example, to a channel of a communication medium, having a specific bandwidth (e.g., 6 to 8 MHz) and occupying a particular frequency band. The physical channels have center frequencies that are spaced 6 to 8 MHz apart. Each physical channel may carry an MPEG transport stream having one or more programming channels, depending on the bit rate of the programming channels.

The term “programming channel” refers to a channel that includes audio, video, and auxiliary signals associated with a program, such as a movie program or a news program. Auxiliary signals may include, e.g., captioning information. Each programming channel may have a bit rate of 3 Mbps to 18 Mbps, depending on the program content and on whether the program is standard definition (having 704×480 resolution for NTSC (National Television System Committee) standard, 768×576 or 1024×576 for PAL (Phase Alternating Line) standard) or high definition (having 1280×720 or 1920×1080 resolution).

A demodulator 114 demodulates the modulated transport stream 112 according to VSB or QAM demodulation to generate an MPEG transport stream (TS) 116, which includes a series of fixed-length packets. The system controller 122 configures the demultiplexer 118 differently depending on the destination of the signals output by the demultiplexer 118.

In some examples, the system controller 122 configures the demultiplexer 118 so that the output of the demultiplexer 118 can be sent to the MPEG decoder 152. In this case, the demultiplexer 118 demultiplexes the transport stream 116 to separate the multiplexed programming channels into individual programming channels, and to separate video, audio, and auxiliary signals in each programming channel into separate streams. The output of the demultiplexer can be packetised elementary stream (PES) packets.

In some examples, the system controller 122 configures the demultiplexer 118 so that the output of the demultiplexer 118 is recorded in the hard disk drive 102. In this case, the output of the demultiplexer 118 may be MPEG transport stream packets. Depending on how many programs that the user wishes to record, the output of the demultiplexer 118 may include one or more digital TV programs.

When the digital TV programs are recorded to the hard disk drive 102, the system controller 122 configures the demultiplexer 118 (by setting registers 119 in the demultiplexer 118) to detect certain events, codes, or patterns in the packets, and write relevant information to a meta data file. For example, the demultiplexer 118 may write to the meta data file information about which packets include the start of intra-coded (I), predictive-coded (P), or bi-directionally predictive-coded (B) frames.

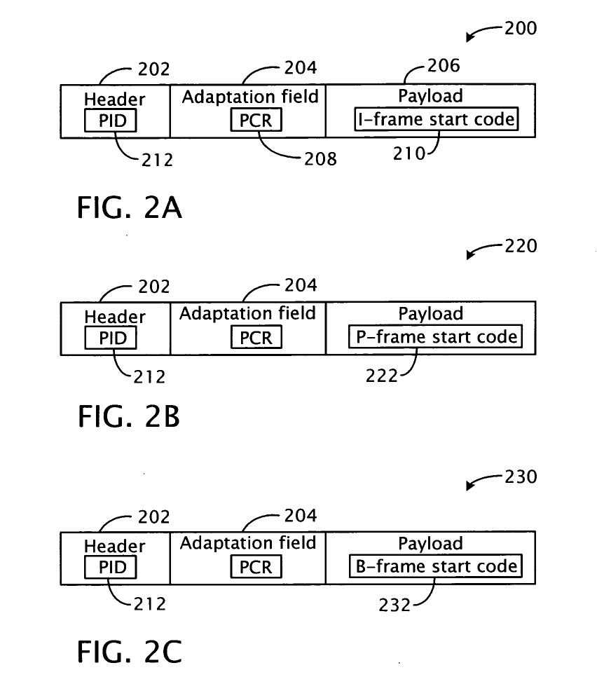

In FIG. 2A, an example transport stream packet 200 is 188 bytes long and includes a header 202, an adaptation field 204, and a payload 206. The first byte of the header 202 is a sync byte that is used to establish packet boundaries to allow random access into the transport stream. A transport stream includes time-multiplexed packets of different streams. A packet identifier (PID) 212 is included in the header to identify the packets belonging to a given stream. For example, a program typically includes at least one audio stream and one video stream. The packets containing the audio stream all will have one PID, and the packets containing the video stream all will have a second PID.

The adaptation field 204 may include a program clock reference (PCR) 208, which is used to synchronize the decoding and playback of a program and to synchronize encoder and decoder clock references. PCRs are inserted into a transport stream by the MPEG encoder, e.g., on average a PCR is inserted every 30 milliseconds, and represents a current value of a counter at the encoder, in which the counter increments at 27 MHz. The PCRs can be used to establish a local timer, or local system clock, for use by the decoder.

The payload 206 may include audio data, video data, private data defined by the content provider, or table sections that provide information about the programs in the stream and the PIDs of the audio and video streams for each program. For example, the payload 206 may include a start code 210 of an I-frame, which indicates that the payload 206 belongs to the first packet of an I-frame. Similarly, as shown in FIGS. 2B and 2C, the payloads 206 of packets 220 and 230 may include the start codes 222 and 232 of a P-frame and a B-frame, respectively, which indicate the payloads belong to the first packet of a P-frame and a B-frame, respectively.

As the demultiplexer 118 processes each packet and stores the packets in the hard disk drive 102, a transport stream packet counter 125 increments by 1 each time the demultiplexer 118 processes a new packet. The packet counter is initially set to 0. The count number of the transport stream packet counter, referred to as the transport stream packet number, can be used to determine the location of a particular packet within a sequence of packets stored in the hard disk drive 102.

In some examples, the system controller 122 configures the demultiplexer 118 to, while processing a sequence of transport stream packets, detect the I-, P-, and B-frame start codes of packets and to record the packet numbers of those packets in a meta data file. The meta data file can then be used to quickly locate the I-, P-, and B-frames, which is useful when fast forward or fast reverse displaying a video while preserving the original frame rate (about 30 frames/sec for NTSC and 25 frames/sec for PAL) and data rate of the video.

Locating the I-, P-, and B-frames is useful because, when displaying MPEG encoded video, if the transport stream packets were sent to the MPEG decoder faster than the normal frame rate (e.g., to increase the frame rate), the MPEG decoder may not be capable of processing the packets. To accommodate the MPEG decoder, it may not be practical to drop packets on a strictly periodic basis, such as by dropping 75% of the packets and sending the remaining 25% of the packets at a normal frame rate to increase the video playback speed to 4 times the normal speed, because only the I-frames are independently coded, and the P- and B-frames need other frames for proper decoding. If those other frames were dropped, it may not be possible to decode certain P- and B-frames. On the other hand, if only I-frames were sent to the decoder at the normal frame rate, the total bandwidth may still increase beyond the capability of the decoder because I-frames usually have larger sizes than P- or B-frames, and the decoder is designed to process a combination of I-, P, and B-frames. Thus, a mix of I-, P-, and B-frames are selectively sent to the decoder during fast forward or reverse display of video to preserve the original frame rate and to keep the data rate within the processing limits of the MPEG decoder.

Table 1 below shows an example of the information recorded in the meta data file. Storing the packet numbers of the I-, P-, and B-frames in the meta data file allow the recorder 100 to quickly jump from one frame to another based on the specified speed of playback.

TABLE 1

| TS packet numbers | TS packet numbers | TS packet numbers |
|---|---|---|
| that have | that have | that have |
| I-frame start code | P-frame start code | B-frame start code |
| 1 | 60 | 20 |
| 300 | 120 | 40 |
| 600 | 180 | 80 |
| 900 | 240 | 100 |
| 1200 | 360 | 140 |
| 1500 | 420 | 160 |

The another example, the meta data file may include information about which packet number corresponds to the i-th second, j-th minute of a stream. During playback, this information allows the transport stream packets to be transferred at a rate equivalent to the rate at which they were recorded.

In some examples in which the digital TV program is stored in the hard disk drive 102, the transport stream demultiplexer 118 temporarily writes the transport stream packets (e.g., 200, 220, 230) and the meta data file to the DRAM 120. The transport stream packets and the meta data file are then transferred from the DRAM 120 to the hard disk drive 102 through an IEEE 1394 interface 124. The system controller 122 controls the operations of the transport demultiplexer 118 and the IEEE 1394 interface 124 through a command bus 150. The IEEE 1394 interface 124 accesses the DRAM 120 through a memory bus 164.

To perform playback in trick mode (such as pausing a live TV program, instant replay of a portion of a program, skipping a portion of a program, fast forward or fast reverse display of a program, or displaying a program in forward or reverse slow motion), the system controller 122 first retrieves the meta data file stored in the hard disk drive 102 through the IEEE 1394 interface 124, and temporarily writes the meta data file to the DRAM 120. Based on a user-selected display rate in the trick mode (for example, fast forward at 3× speed) and the information in the meta data file, the recorder 100 controls the transfer of the transport stream packets and the selection of which packets to transport from the hard disk drive 102 to the DRAM 120 for display.

To watch a digital TV program, the demultiplexer 118 separates the incoming multiplexed streams according to PIDs and stores the demultiplexed streams in separate queues in the DRAM 120. The packets in the queues are decoded by the MPEG decoder 152 according to MPEG decoding to generate decoded video and audio data. Decoding of video data includes inverse scanning, inverse quantization, inverse discrete cosine transformation, and motion compensation. During motion compensation, reference frames such as I- or P-frames are stored in the DRAM 120, and are used to reconstruct compressed frames such as P- or B-frames based on motion compensation vectors. The reconstructed P- or B-frames may also be stored in the DRAM 120.

An audio digital-to-analog converter 154 converts the audio data to analog format, which is output to speakers 156. A video post-processor 158 performs video post-processing to improve image quality, which may include, e.g., a de-blocking process to smooth the transitions between adjacent macroblocks of an image, a de-ringing process to remove sudden transitions from one image to a subsequent image, a scaling process to scale the image to fit the resolution of the display, and a color space transformation to adjust the color profile of the image according to the color gamut of the display. A TV encoder 160 encodes the post-processed video according to PAL (phase-alternating line), NTSC (National Television Systems Committee), or SECAM (sequentiel couleur avec mémoire) standard, and sends the encoded signal to a television 162.

The user can record digital TV programs directly to a Blu-ray disc 107, which supports direct recording of an MPEG transport stream. When recording directly to the Blu-ray disc 107, the demultiplexer 118 outputs the transport stream packets and does not generate meta data. The output of the transport stream demultiplexer 118 is sent to the Blu-ray Disc recorder 106 through an IEEE 1394 interface 126. The system controller 122 sends commands through the IEEE 1394 interface 126 to an embedded controller 128 to control the operations of the Blu-ray Disc recorder 106, which records the digital TV program into the Blu-ray disc 107.

To play back the digital TV programs recorded on the Blu-ray disc 107, the transport stream packets are read from the Blu-ray disc 107, demultiplexed by the transport stream demultiplexer 118, and processed by the MPEG decoder 152 as described above.

A useful feature of the digital TV recorder 100 is that, when digital TV programs are recorded in the hard disk drive 102, the user can transfer one or more of the recorded programs to the Blu-ray Disc recorder 106 for recording to Blu-ray discs. The user can either transfer all of the programs in a transport stream recorded in the hard disk drive 102 to the Blu-ray Disc recorder 106, or selectively transfer a subset of the recorded programs.

When digital TV programs are stored in the hard disk drive 102, a table of contents is also stored in the disk drive 102. The table of contents includes, e.g., information about the titles, lengths, and time of recording of the programs. The controller 122 may run a menu program that allows the user to search the hard disk drive 102 to select programs according to certain criteria, such as programs that are recorded within a certain date and time range, or programs having certain keywords in the titles. The controller 122 may generate a list of programs according to the user's search criteria, and provide check boxes to allow the user to select which ones from among the list of programs to watch.

The menu program may also allow the user to select which ones from among the list of programs to record to a Blu-ray disc 107. If the programs selected by the user include all of the programs of a transport stream, the entire transport stream is transferred from the hard disk drive 102 to the Blu-ray Disc recorder 106. If the programs selected by the user include fewer than all of the programs of a transport stream, the transport stream is sent to the transport demultiplexer 118 to filter the packets belonging to the programs selected by the user. The filtered packets are then stored in the Blu-ray Disc recorder 106.

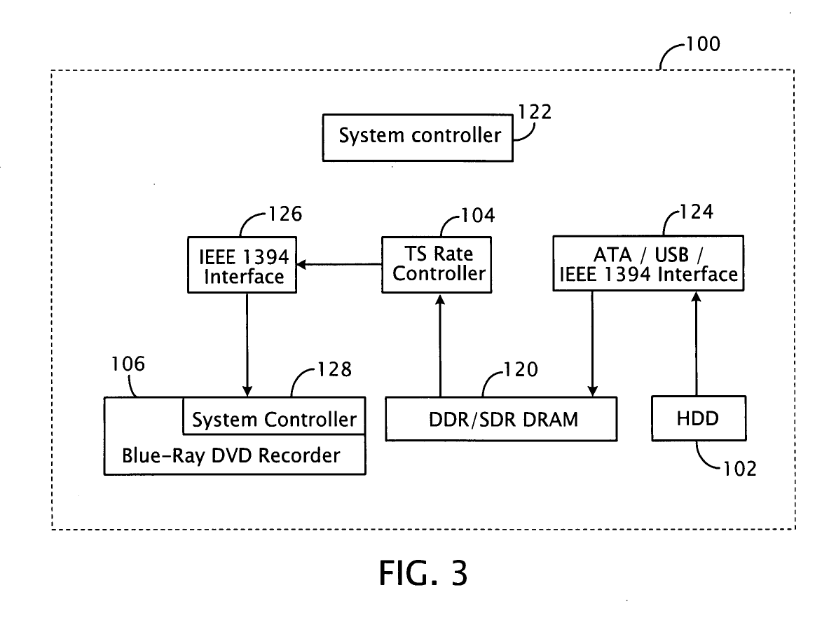

FIG. 3 shows an example of the path of data transfer from the hard disk drive 102 to the Blu-ray Disc recorder 106 when all of the programs in a transport stream are transferred to the Blu-ray Disc recorder 106. A copy of the packets is transferred from the hard disk drive 102 to the DRAM 120 through the IEEE 1394 interface 124, then transferred from the DRAM 120 to the Blu-ray Disc recorder 106 through a transport stream transfer rate controller (abbreviated as TS rate controller) 104 and the IEEE 1394 interface 126.

The rate of data transfer from the hard disk drive 102 to the DRAM 120 is limited by the data transfer rate of the IEEE 1394 interface 124, assuming that the hard disk drive 102 and the DRAM 120 have faster data transfer rates than the interface 124. The IEEE 1394 interface 124 has a data transfer rate of 400 Mbps or 800 Mbps, depending on whether the interface 124 complies with IEEE 1394a or IEEE 1394b standard, respectively.

The TS rate controller 104 regulates the transfer rate of transport streams from the DRAM 120 to the Blu-ray Disc recorder 106. The ISO 13818-1 standard specifies that a transport stream should be sent to a transport stream system target decoder at a constant rate. For example, the transfer rate can be set to about 19.39 Mbps, which complies with the ATSC standard. The Blu-ray Disc recorder 106 complies with the ISO 13818-1 standard and is designed to accept an MPEG transport stream having a data rate of, e.g., about 19.39 Mbps, which is slower than the data transfer rate of the IEEE 1394 interface 126. The TS rate controller 104 regulates the rate of data transfer to be about 20 Mbps, consistent with the transfer rate acceptable to the Blu-ray Disc recorder 106.

In some examples, transport stream packets of a digital television signal that are processed by the tuner 108, demodulator 114, and demultiplexer 118 are stored in the DRAM 120 and transferred to a storage device (such as the recorder 106), without storing the transport stream packets in the hard disk drive 102. In some examples, the storage device may include a hypothetical decoder model, referred to as a transport-stream system target decoder, which complies with the MPEG standard. The transport-stream system target decoder defines certain constraints to ensure smooth decoding of the packets to prevent buffer overflow and underflow. The transport stream packets may include live programs that convey real-time content, so the transport-stream system target decoder is configured to operate at a rate at which the live programs are encoded. The TS rate controller 104 controls the transfer rate of packets from the DRAM 120 to the IEEE 1394 interface 126 to prevent buffer overflow or underflow at the Blu-ray Disc recorder 106.

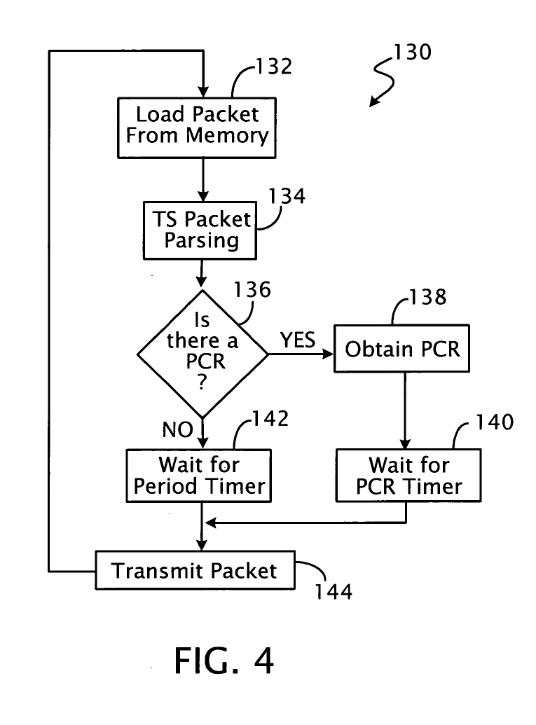

FIG. 4 shows a process 130 according to which the TS rate controller 104 regulates the transfer rate of transport stream packets based on the program clock references. The transport stream packets to be transmitted are initially buffered in a memory such as the DRAM 120. The TS rate controller 104 loads 132 a packet from the memory, parses 134 and examines the packet to determine 136 whether there is a PCR in the adaptation field of the packet. If there is a PCR, the PCR is retrieved 138 and compared with a local PCR timer (or local system clock) at the decoder. The PCR provides information about the relative time at which the packet was encoded. For example, the PCR may indicate that the packet was received by the encoder at the i-th minute and j-th second relative to the beginning of the program, the i and j values being determined based on a local timer at the encoder. The local PCR timer at the decoder may be a counter operating at a clock frequency of 27 MHz, in which the clock frequency is adjusted by the PCR to synchronize the local PCR timer at the decoder with the local timer at the encoder. The TS rate controller 104 waits 140 and halts the packet until the local PCR timer at the decoder is equal to or greater than the value represented by the PCR retrieved from the packet, after which the packet is transferred to the Blu-ray Disc recorder 106 through the IEEE 1394 interface 126.

A “period timer” is used to control transfers of packets that do not have PCRs. The period timer continuously increases a count as time passes, and the count is reset to zero each time a packet is sent to the Blu-ray Disc recorder 106. For a packet that does not have a PCR field, the TS rate controller 104 waits 142 until the period timer indicates that a predetermined period of time, referred to as the “predetermined packet interval,” has passed since the last packet was sent to the Blu-ray Disc recorder 106. The predetermined packet interval can be determined by parsing the transport stream, counting the number of packets between two packets both having PCRs, or other means. The predetermined packet interval is not necessarily fixed, and may change over time based on information extracted from the transport stream packets.

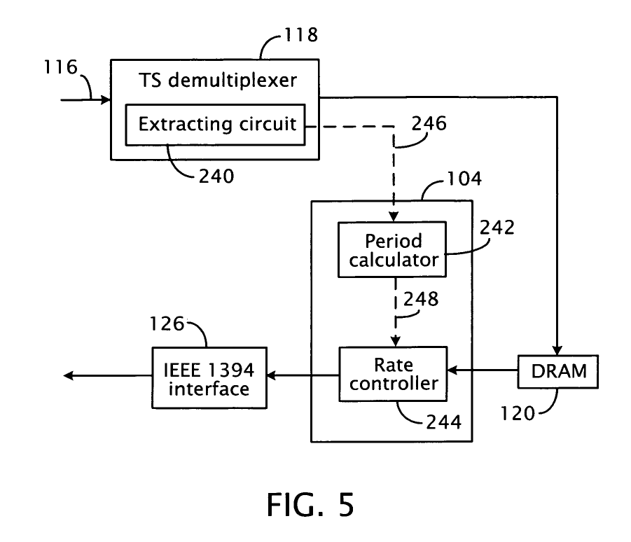

Referring to FIG. 5, in some examples, the transport stream demultiplexer 118 includes an extracting circuit 240 that obtains transfer rate control information from the transport stream packets before the packets are sent to the DRAM 120. Examples of transfer rate control information include PCRs and memory addresses where the packets are to be stored. The transfer rate control information obtained by the circuit 240 is stored in a buffer or the DRAM 120. The TS rate controller 104 includes a period calculator 242 that computes the predetermined packet interval based on the transfer rate control information.

In some examples, the period calculator 242 calculates the predetermined packet interval by determining a time difference M between two transport stream packets, e.g., packets A and B, that have PCRs. The time difference M can be derived from differences in the PCRs of the packets A and B. The time difference M is divided by N, in which N−1 is the number of packets between the two packets A and B (which can be counted by using a counter, or calculated based on a difference in memory addresses of the two packets A and B). The period calculator 242 stores the predetermined packet interval in a buffer or the DRAM 120.

A rate controller 244 controls the transfer rate of packets without PCRs from the DRAM 120 to the IEEE 1394 interface 126 based on the predetermined packet interval. The rate controller 244 waits until the period timer indicates that the predetermined packet interval has passed since the last packet was sent to the interface 126 before sending another packet to the interface 126. The dashed lines 246 and 248 show a flow of information used for calculating the predetermined packet interval and controlling the transfer rate of packets from the DRAM 120 to the interface 126.

In some examples, the IEEE 1394 interface 124 includes an extracting circuit (not shown) that obtains transfer rate control information from the transport stream packets that are sent from the hard disk drive 102 to the DRAM 120. The transfer rate control information is used by the period calculator 242 to compute the predetermined packet interval, which is used by the rate controller 244 to control the transfer rate of packets without PCRs from the DRAM 120 to the IEEE 1394 interface 126, as described above.

In other examples, the encoder of the transport stream packets embeds rate information in the transport stream packets in an optional field. In such cases, the predetermined packet interval can be derived from the embedded rate information, and used by the rate controller 244 to control the transfer rate of packets as described above.

In some applications or devices, the predetermined packet interval is set to a fixed value when the transport stream packets are encoded. When processing transport stream packets from such applications or devices, the rate controller 244 controls the transfer rate according to the fixed value.

In some examples, the predetermined period of time is calculated for all packets that do not have PCRs. For example, assume that the transport stream packets include packets A, B, C, . . . that have PCRs. A first predetermined packet interval is calculated for controlling transfer of packets (without PCRs) between packets A and B. A second predetermined packet interval is calculated for controlling transfer of packets (without PCRs) between packets B and C, and so forth.

In other examples, the extracting circuit 240 estimates the predetermined period of time or transfer rate for a packet based on the transfer rate control information of previous packets. For example, the transfer rate may be determined by direct calculation, low-pass filtering, or the moving average over the transfer rate control information of previous packets. Determining the transfer rate of later packets based on information extracted from earlier packets is effective when the encoding rate of the transport stream packets changes smoothly or remains substantially constant.

In the discussion above, the value MIN is used to determine the predetermined packet interval that affects when packets without PCRs are sent to the interface 126. When M is not an integer multiple of N, MIN will not be an integer. A more complicated calculator that performs real number divisions can be used to compute MIN. Alternatively, as discussed below, a calculator that performs only integer operations can be used to determine intervals that approximate MIN.

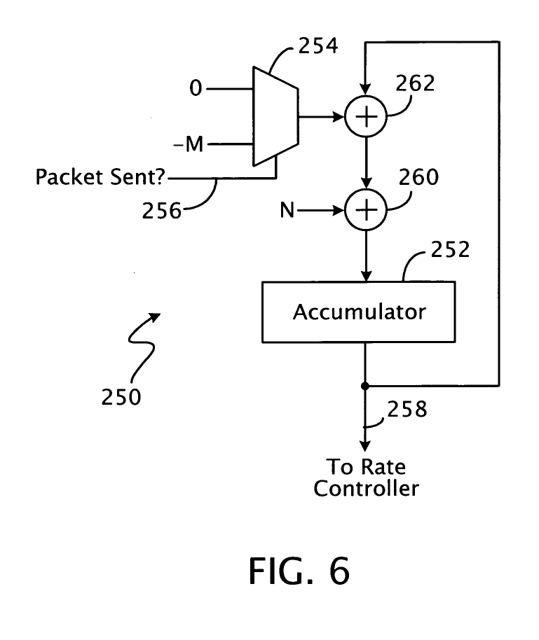

Referring to FIG. 6, in one example, the period calculator 242 includes an interval calculator 250 that calculates the predetermined packet interval based on the numbers M and the N, in which M represents the time different between two packets A and B having PCRs, and N−1 represents the number of packets between the packets A and B (not including packets A or B). The interval calculator 250 includes an accumulator 252 that is initially set to zero. A multiplexer 254 receives inputs 0 and −M, and is controlled by a signal 256 that indicates whether a packet was sent from the DRAM 120 to the IEEE 1394 interface 126 (see FIG. 5).

The interval calculator 250 receives a clock signal (not shown), and for each period of the clock signal, adders 260 and 262 add the number N and the output of the multiplexer 254, respectively, to the value stored in the accumulator 252. Depending on whether a packet is or is not sent to the interface 126, the output of the multiplexer 254 is −M or 0, respectively. Thus, if a packet is sent to the interface 126, the adder 262 adds −M to the number stored in the accumulator 252. The rate controller 244 allows another packet to be sent to the interface 126 when the accumulator 248 outputs a positive number on a signal line 258.

In one example, the clock signal has a clock frequency of 27 MHz, the time difference M between packets A and B is 1000 periods (i.e., M=1000), and there are two packets (without PCRs) between the packets A and B with PCRs (N=3). Initially, the accumulator 252 is set to 0. At clock period 0, the packet A is sent to the interface 126. At the first clock period, the adder 260 adds N=3 and the adder 262 adds −M=−1000 to the value stored in the accumulator 252, so that the value stored in the accumulator 252 becomes −997. During each successive clock period, the adder 260 adds N=3 to the number stored in the accumulator 252. At the 334-th clock period, the value stored in the accumulator 252 becomes positive (equal to 2), which causes the rate controller 244 to send another packet. Subsequently, the adder 260 adds N=3 and the adder 262 adds −M=−1000 to the value stored in the accumulator 252, so that the accumulator 252 stores the value −995. During each successive clock period, the adder 260 adds N=3 to the number stored in the accumulator 252. At the 667-th clock period, the value stored in the accumulator 252 becomes positive (equal to 1), which causes the rate controller 244 to send another packet to the interface 126.

An advantage of the interval calculator 250 is that, by performing integer operations, the packets can be transferred from the DRAM 120 to the interface 126 at intervals that approximate MIN clock periods, in which MIN can be non-integers (in the above example, MIN= 1000/3=333.333 . . . ). The interval calculator 250 performs operations similar to an integer division to calculate an integer multiple of a clock period for determining when to send a packet. The interval calculator 250 operates as if the remainder of the division operation MIN is accumulated in the accumulator 252 for use in determining when to send another packet. Using this method, the packets are sent at times that approximate integer multiples of MIN without using a complicated circuit to perform real number division operations.

As discussed above, a local PCR timer is used to determine when to send packets with PCRs to the IEEE 1394 interface 126. The local PCR timer can have two states: a reset state and an active state. Initially, the local PCR timer is in the reset state. When a first transport stream packet having a PCR is received at the TS rate controller 104, the local PCR timer enters the active state and loads the PCR. The local PCR timer starts counting, and the rate controller 244 halts the next packet with a PCR until the local PCR timer has a count that is equal to or greater than the PCR of the halted packet.

In one example, if the PCR obtained from the packet has a value that is smaller than or deviates significantly from the count of the PCR timer, the PCR timer returns to the reset state. This may occur when the transport stream packets are not in their original order, or if a system time base changes. When channel change occurs, the PCR timer returns to the reset state because each channel has its own system time base. In these circumstances, the local PCR timer is reset and synchronized with a new time base by entering the reset state. The local PCR timer can also enter the reset state when the transport stream packets are found to be discontinuous. In one example, discontinuity indicator fields in the adaptation field of transport stream packets are monitored to determine whether transport stream packets are discontinuous.

By using the TS rate controller 104 to regulate the transfer rate of packets from the DRAM 120 to the Blu-ray Disc recorder 106, the packets will be sent to the Blu-ray Disc recorder 106 at an acceptable rate even if the transfer rate of the IEEE 1394 interface 124 is much higher than the data rate at which the Blu-ray Disc recorder 106 can accept packets. Without the TS rate controller 104, there may be data overflow at the Blu-ray Disc recorder 106.

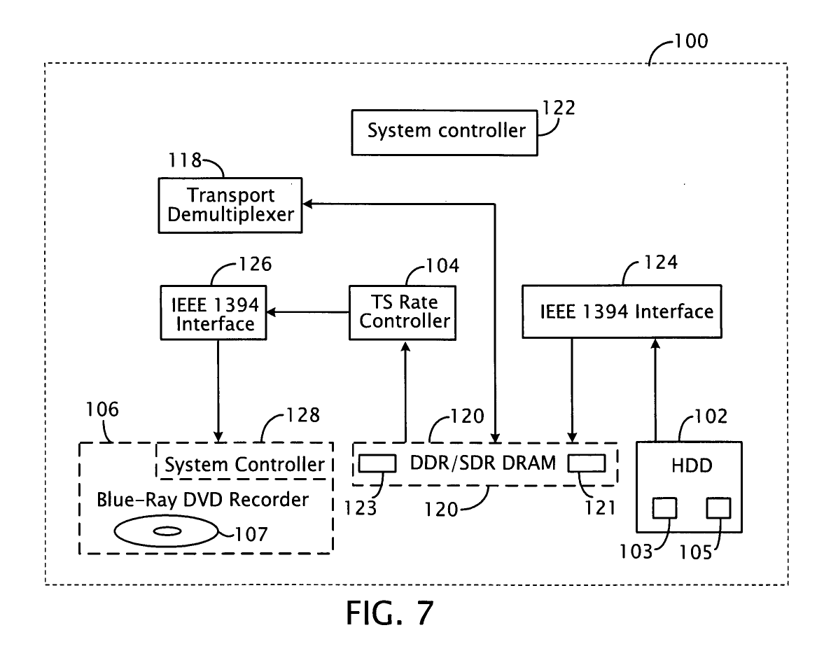

FIG. 7 shows an example of the path of data transfer from the hard disk drive 102 to the Blu-ray Disc recorder 106 when less than all (e.g., a subset) of the programs in a transport stream are transferred to the Blu-ray Disc recorder 106. After the user selects the programs to be recorded to the Blu-ray disc 1107, the system controller 122 determines which transport stream has the selected programs, and transfers a copy of the transport stream packets from the hard disk drive 102 to a first portion 121 in the DRAM 120 through the IEEE 1394 interface 124. The transport demultiplexer 118 filters the packets belonging to programs selected by the user, and stores the filtered packets in a second portion 123 of the DRAM 120. The system controller 122 then transfers the transport stream packets from the second portion 123 to the Blu-ray Disc recorder 106 through the TS rate controller 104 and the IEEE 1394 interface 126.

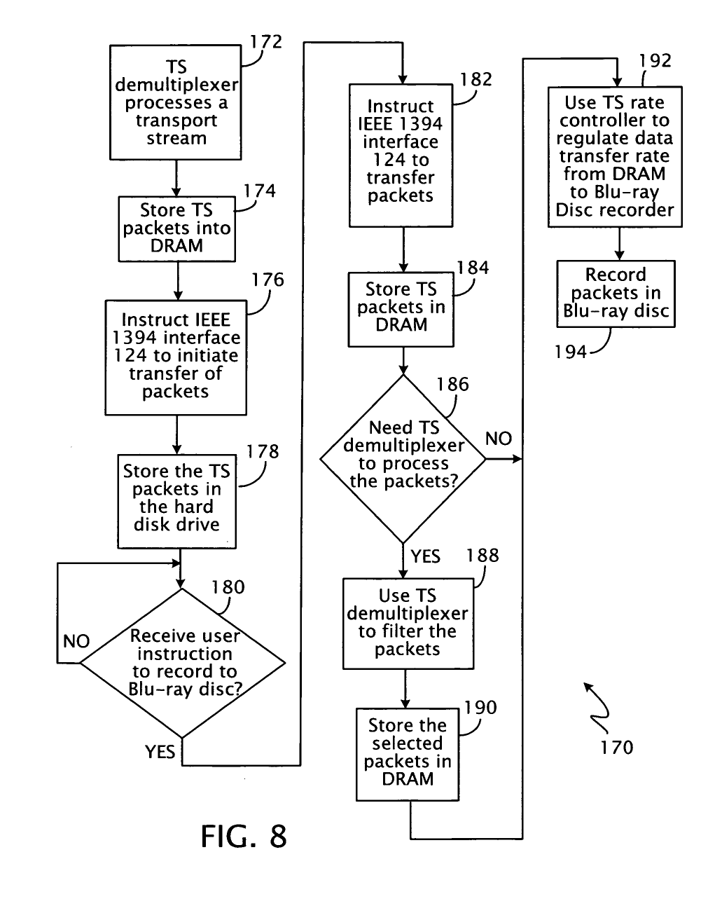

FIG. 8 shows a process 170 in which a digital TV program is first stored to the hard drive 102 then to the Blu-ray disc 107. The transport stream demultiplexer 118 processes 172 the demodulated MPEG transport stream 116, selects the packets associated with the programs that the user wishes to record to the hard disk drive 102, and stores 174 the selected packets in the DRAM 120. The system controller 122 instructs 176 the IEEE 1394 interface 124 to retrieve the transport stream packets from the DRAM 120 and store 178 the packets in the hard disk drive 102.

The controller 122 determines 180 whether instructions have been received from the user to record certain programs to the Blu-ray disc 107. When such instructions are received, the controller 122 instructs 182 the IEEE 1394 interface 124 to retrieve the transport stream packets from the hard disk drive 102 and store 184 the packets into the first portion 121 of the DRAM 120.

The system controller 122 determines 186 whether the transport stream packets need to be processed by the transport stream demultiplexer 118. If the transport stream packets do not need to be processed, the packets are sent to the TS rate controller 104, which regulates 192 the rate of transfer of the transport stream packets to the Blu-ray Disc recorder 106 through the IEEE 1394 interface 126.

If the transport stream packets need to be processed (e.g., because only a subset of the programs included in the transport stream were selected by the user), the packets are sent to the transport stream demultiplexer 118, which filters 188 the packets to select the packets belonging to the programs selected by the user, and stores 190 the selected packets in the second portion 123 of the DRAM 120. The system controller 122 then causes the transport stream packets to be sent to the TS rate controller 104, which regulates 192 the transfer rate of the transport stream packets to the Blu-ray Disc recorder 106 through the IEEE 1394 interface 126. The recorder 106 records 194 the transport stream packets having the user-selected digital TV programs into the Blu-ray disc 107.

Although some examples have been discussed above, other implementations and applications are also within the scope of the following claims. For example, the Blu-ray Disc recorder 106 can be replaced by a digital VHS recorder, a High-Density DVD recorder, or other types of recording devices. The recorder 106 may also be replaced by a device that can record to multiple media formats, such as a Blu-ray disc and a digital VHS tape. The hard disk drive 102 can be replaced by other types of storage devices, such as other rotating medium, removable hard drives, a large capacity flash memory, or storage that uses micro-electro-mechanical systems (MEMS). The DRAM 100 can be, e.g., synchronous DRAM, double data rate DRAM, or reduced latency DRAM. The DRAM 100 can be replaced by other types of memory, such as static random access memory (SRAM), including quad data rate SRAM. The demodulator 114 may be included in the digital tuner 108. The IEEE 1394 interface 124 can be replaced by, e.g., a parallel AT attachment (ATA) interface, serial ATA (SATA) interface, or a Universal Serial Bus (USB) interface.

In the description above, the meta data is recorded in a meta data file that is separate from the MPEG transport stream packets stored in the hard disk drive. The meta data can also be embedded in the MPEG transport stream packets, such that the MPEG transport stream packets have a non-standard format. During playback of the digital TV program stored in the hard disk drive, the packets are processed to remove the meta data before the packets are decoded by the MPEG decoder 152, or transferred to the Blu-ray Disc recorder 106.

In FIG. 1, the TS rate controller 104 controls the rate of transfer of the packets from the DRAM 120 to the Blu-ray Disc recorder 106. The TS rate controller 104 can also be configured to control the rate of transfer of the packets from the hard disk drive 102 to the DRAM 120. The TS rate controller 104 may control the rate of transfer of the packets from the hard disk drive 102 to the DRAM 120, or from the DRAM 120 to the Blu-ray Disc recorder 106, based on transfer control information embedded in at least some of the packets, in which the transfer control information can be program clock references or other time information.

The system controller 122 can be made of one chip or have components in several chips. The system controller 122, the transport stream demultiplexer 118, the IEEE 1394 interfaces 124, 126, and the transport stream rate controller 104 can be integrated in a single chip. The single chip may also include the MPEG decoder 152, the audio DAC 154, the video post-processor 158, and the TV encoder 160.

A digital recorder using the techniques described above can be used to record multimedia programs other than digital TV programs to a first storage (e.g., a hard drive), and transfer the programs to a second storage (e.g., a Blu-ray disc). The multimedia program can comply with a standard that is different from MPEG, in which the multimedia program is transmitted in the form of packets, not necessarily of the same size, and at least some of the packets have time information (e.g., clock references). The rate of transfer of the multimedia programs from the first storage to the second storage is regulated based on the time information in the packets.

What is claimed is:

1. An apparatus comprising:
a first controller to control transfer of MPEG transport stream packets from a first storage to a dynamic random access memory (DRAM), and to control transfer of at least some of the MPEG transport stream packets from the DRAM to a second storage; and
a second controller to regulate at least one of (a) a rate of transfer of the packets from the first storage to the DRAM and (b) a rate of transfer of the packets from the DRAM to the second storage, based on transfer rate control information in the MPEG transport stream packets.

2. The apparatus of claim 1 in which the transfer rate control information comprises time information.

3. The apparatus of claim 2 in which the time information comprises program clock references.

4. The apparatus of claim 2 in which the second controller regulates the rate of transfer based on a comparison of embedded transfer rate control information with local transfer rate control information.

5. The apparatus of claim 4 in which the local transfer rate control information comprises local program clock references that are used for decoding the transport stream packets.

6. The apparatus of claim 1 in which the second controller regulates the rate of transfer also based on information about a previous packet that was sent to the second storage.

7. The apparatus of claim 1 also comprising a user interface to allow a user to select at least one program to transfer from the first storage to the second storage.

8. The apparatus of claim 7 also comprising a transport stream demultiplexer to select transport stream packets associated with the user-selected program.

9. The apparatus of claim 8 in which the transport stream demultiplexer selects the transport stream packets based on packet identifiers.

10. A digital recorder comprising:
a demultiplexer to generate a data file of information about particular packets in a stream of MPEG packets, the information being configured to enable faster fetching of the particular packets;
a hard disk drive to store the MPEG packets and the data file;
a recorder to store at least some of the MPEG packets on a removable medium;
a first controller to control playback of the MPEG packets from the hard disk drive based at least in part on the data file and to control storage of the MPEG packets in the hard disk drive and transfer of the some of the MPEG packets from the hard disk drive to the recorder; and
a memory to temporarily store packets transferred from the hard disk drive to the recorder.

11. The digital recorder of claim 10, also comprising a second controller to regulate a transfer rate of the MPEG packets from the hard disk drive to the recorder according to transfer rate control information in the MPEG packets.

12. The digital recorder of claim 11 in which the transfer rate control information comprises time information.

13. The digital recorder of claim 12 in which the time information comprises program clock references.

14. The digital recorder of claim 10 in which the controller controls selective decoding of the MPEG packets to enable trick mode operation.

15. The digital recorder of claim 14 in which the controller selects the MPEG packets to be decoded based on information in the data file.

16. The digital recorder of claim 10 in which the data file identifies packets according to whether they require other packets in order to be processed or can be processed independently.

17. The digital recorder of claim 16 in which the data file includes information about which packets are at the start of at least one of intra-coded, predictive-coded, and bi-directionally predictive-coded frames.

18. The digital recorder of claim 10 also comprising a demodulator to demodulate a modulated MPEG transport stream signal and generate the stream of MPEG packets.

19. A digital recorder comprising:
a demultiplexer to insert data about particular packets of a series of MPEG transport stream packets into at least some of the MPEG transport stream packets, the data being configured to aid faster fetching of the particular packets; and
a controller to control transfer of at least some of the MPEG transport stream packets from a first storage to a second storage, the inserted data being removed prior to sending the MPEG transport stream packets to the second storage.

20. An apparatus comprising:
a controller to regulate a rate of transfer of MPEG transport stream packets from a first storage device to a second storage device based on transfer rate control information derived from at least some of the MPEG transport stream packets.

21. The apparatus of claim 20 in which the transfer rate control information comprises time information.

22. The apparatus of claim 20 in which the time information comprises program clock references (PCRs).

23. The apparatus of claim 22 in which the controller comprises a local PCR timer, wherein a packet having a PCR is transferred when the local PCR timer has a value that is equal to or greater than a value of the PCR.

24. The apparatus of claim 23 in which the local PCR timer, upon receiving a first packet having a PCR, stores the value of the PCR and starts to increment a counter periodically.

25. The apparatus of claim 23 in which the local PCR timer is reset when the value of the PCR deviates more than a predetermined amount from the value of the local PCR timer.

26. The apparatus of claim 22 in which the controller regulates transfers of packets without a PCR based on a difference between PCRs of two packets that have PCRs and a number of packets between the two packets that have PCRs.

27. The apparatus of claim 26 in which the controller performs integer operations.

28. The apparatus of claim 27 in which the controller comprises an accumulator and adders.

29. The apparatus of claim 22 in which the rate of transfer of a packet is estimated according to the transfer rate control information derived from previous packets having PCRs.

30. The apparatus of claim 29 in which the rate of transfer is estimated by applying at least one of averaging, low-pass filtering, and moving averaging operations to the transfer rate control information derived from previous packets having PCRs.

31. The apparatus of claim 20 in which the controller determines the rate of transfer according to a parameter representing a target transfer rate, wherein the parameter is embedded in the MEPG transport stream packets.

32. The apparatus of claim 20 in which the controller regulates the rate of transfer based on a comparison of the derived transfer rate control information with local transfer rate control information.

33. The apparatus of claim 32 in which the local transfer rate information comprises local program clock references that are used for decoding the transport stream packets.

34. The apparatus of claim 20 in which the controller regulates the rate of transfer also based on information about a previous packet that was sent to the second storage device.

35. The apparatus of claim 20 in which the information about the previous packet comprises a duration of time since the previous packet was sent to the second storage device.

36. The apparatus of claim 20 in which the first storage device comprises at least one of a rotating medium and a dynamic random access memory.

37. The apparatus of claim 20 in which the second storage device comprises at least one of a digital VHS recorder, a Blu-ray Disc recorder, and a High-Density DVD recorder.

38. The apparatus of claim 20 in which the transport stream transfer rate controller regulates the rate of transfer without performing video compression or decompression.

39. A method comprising:
transferring MPEG transport stream packets from a first storage to a dynamic random access memory (DRAM);
transferring at least some of the MPEG transport stream packets from the DRAM to a second storage; and
regulating at least one of (a) a rate of transfer of the packets from the first storage to the DRAM and (b) a rate of transfer of the packets from the DRAM to the second storage, based on transfer rate control information in the MPEG transport stream packets.

40. The method of claim 39 in which the transfer rate control information comprises time information.

41. The method of claim 40 in which the time information comprises program clock references in the packets.

42. The method of claim 39 in which regulating the rate of transfer comprises regulating the rate of transfer based on a comparison of the transfer rate control information embedded in the packets with local transfer rate control information.

43. The method of claim 42 in which the local transfer rate control information comprises a local program clock reference timer used for decoding the transport stream packets.

44. The method of claim 39 in which regulating the rate of transfer comprises regulating the rate of transfer also based on information about a previous packet that was sent to the second storage.

45. The method of claim 44 in which the information about the previous packet comprises a duration of time since the previous packet was sent to the second storage.

46. The method of claim 39 also comprising providing a user interface to allow a user to select at least one program to transfer from the first storage to the second storage.

47. The method of claim 46 also comprising selecting transport stream packets associated with the user-selected program.

48. The method of claim 47 in which selecting the transport stream packets comprises selecting the transport stream packets based on packet identification (PID) codes.

49. A method comprising:
generating a data file of information about particular packets in a stream of MPEG packets, the information being configured to enable faster fetching of the packets;
storing the MPEG packets and the data file in a hard disk drive;
controlling decoding of the MPEG packets retrieved from the hard disk drive based at least in part on the data file;
transferring at least some of the MPEG packets from the hard disk drive to a memory; and
transferring at least some of the MPEG packets from the memory to a removable medium.

50. The method of claim 49 also comprising regulating at least one of (a) a transfer rate of the MPEG packets from the hard disk drive to the memory and (b) a transfer rate of the MPEG packets from the memory to the removable medium, based on transfer rate control information embedded in at least some of the MPEG transport stream packets.

51. The method of claim 50 in which the transfer rate control information comprises time information.

52. The method of claim 49 also comprising selectively decoding the MPEG packets to enable trick mode operation.

53. The method of claim 52 also comprising selecting packets to be decoded based on information in the data file.

54. The method of claim 49 in which the data file includes information about which packets are associated with the start of at least one of intra-coded, predictive-coded, and bi-directionally predictive-coded frames.

55. The method of claim 49 also comprising demodulating a modulated MPEG transport stream signal and generating the stream of MPEG packets.

56. A method comprising:
inserting data about particular packets of a series of MPEG transport stream packets into at least some of the MPEG transport stream packets, the data being configured to aid faster fetching of the particular packets; and
transferring at least some of the MPEG transport stream packets from a first storage to a second storage, including removing the inserted data prior to sending the MPEG packets to the second storage.

57. A method comprising:
regulating a rate of transfer of MPEG transport stream packets from a first storage to a second storage based on transfer rate control information derived from at least some of the MPEG transport stream packets.

58. The method of claim 57 in which the transfer rate control information comprises time information.

59. The method of claim 58 in which the time information comprises program clock references (PCRs).

60. The method of claim 59 in which the method further comprises transferring a packet having a PCR when a local PCR timer has a value that is equal to or greater than a value of the PCR.

61. The method of claim 60 in which the local PCR timer, upon receiving a first packet having a PCR, stores the value of the PCR and starts to increment a counter periodically.

62. The method of claim 60 in which the local PCR timer is reset when the value of the PCR deviates more than a predetermined amount from the value of the local PCR timer.

63. The method of claim 59, further comprising regulating a rate of transfer of a packet without a PCR based on a difference between PCRs of two packets having PCRs and a number of packets between the two packets that have PCRs.

64. The method of claim 63, further comprising performing integer operations to determine a time interval between packets that do not have PCRs.

65. The method of claim 59 further comprising estimating the rate of transfer for packets without PCRs based on the transfer rate control information derived from previous packets having PCRs.

66. The method of claim 65 in which the rate of transfer is estimated by at least one of averaging, low-pass filtering, and moving averaging the transfer rate control information derived from previous packets having PCRs.

67. The method of claim 57 in which the rate of transfer is determined based on a parameter representing a target transfer rate, wherein the parameter is embedded in the MEPG transport stream packets.

68. The method of claim 57 in which regulating the rate of transfer comprises regulating the rate of transfer based on a comparison of the embedded transfer rate control information with local transfer rate control information.

69. The method of claim 57 in which the local transfer rate information comprises local program clock references that are used for decoding the transport stream packets.

70. The method of claim 57 in which regulating the rate of transfer comprises regulating the rate of transfer also based on information about a previous packet that was sent to the second storage.

71. The method of claim 57 in which the information about the previous packet comprises a duration of time since the previous packet was sent to the second storage.

72. The method of claim 57 in which regulating the rate of transfer comprises regulating a rate of transfer of MPEG transport stream packets from a hard disk drive to at least one of a digital VHS recorder, a Blu-ray Disc recorder, and a High-Density DVD recorder.

73. The method of claim 57 in which regulating the rate of transfer comprises regulating the rate of transfer without performing video compression or decompression.
